(19) United States
(12) Patent Application Publication
(10) Pub. No.: US 2005/0271969 A1
(43) Pub. Date: Dec. 8, 2005

(54) Method of preparing toner

(75) Inventors: Seok-hoon Choi, Suwon-si (KR); Sang-deok Kim, Seoul (KR); Duck-hee Lee, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., LTD., Suwon-si (KR)

(21) Appl. No.: 11/143,601

(22) Filed: Jun. 3, 2005

(30) Foreign Application Priority Data
Jun. 3, 2004 (KR) 2004-0040317

(51) Int. Cl. G03G 9/08

(52) U.S. Cl. 430/137.1

(57) ABSTRACT

A method of preparing a toner includes: adding a first external additive having an average primary particle diameter of between about 30 nm and 200 nm to toner particles including a binder resin and a colorant and stirring the first external additive with the toner particles to form a first external additive layer on the surfaces of the toner particles; and adding a second external additive having an average primary particle diameter between about 5 nm and 30 nm to the toner particles having the first external additive layer and stirring the second external additive with the toner particles to form second external additive layers on the first external additive layers. A stirring line speed of the first external additive is less than a stirring line speed of the second external additive. The method of preparing a toner increases the endurance of the toner and prevents a developing member from being contaminated. External additives having different average primary particle diameters are sequentially added to toner particles including a binder resin and a colorant so that external additives having greater average primary particle diameters are uniformly coated on the surface of the toner particles. Accordingly, a uniform charge and the fluidity of the toner are improved and contamination of a charge roller and other developing members due to a separation of the external additives is prevented.

### CROSS-REFERENCE TO RELATED APPLICATION

This application claims the benefit of Korean Patent Application No. 2004-0040317, filed on Jun. 3, 2004, in the Korean Intellectual Property Office, the disclosure of which is incorporated herein in by reference.

### BACKGROUND OF THE INVENTION

1. Field of the Invention

The present invention relates to a method of preparing a toner for an electrophotographic imaging apparatus. More particularly, the present invention relates to a method of preparing a toner, in which a multi-step external addition process is performed to uniformly distribute external additives to the surfaces of toner particles and increase a surface coating density by the external additives, thereby preventing physical properties of the toner from changing and a developing member from being contaminated due to the separation of the external additives.

2. Description of Related Art

Generally, an electrophotographic imaging apparatus, such as a photocopier, a laser printer, or a facsimile, may produce a desired image by forming an electrostatic latent image on a photoconductive medium, such as a photoconductive drum or a photoconductive belt, developing the electrostatic latent image with a toner having a predetermined color, and transferring the toner image onto a sheet of paper.

Toners used in the electrophotographic imaging apparatuses are divided into two types; liquid toners and dry toners. A dry toner is used in a powder state and the liquid toner is mixed with a liquid carrier.

A dry developing method using a dry toner includes a two component developing method, in which carrier particles for carrying toner particles are used, and a single component developing method, in which a toner is used without a carrier. The single component developing method is classified into a magnetic single component developing method and a nonmagnetic single component developing method. In the magnetic single component developing method, a magnetic single component developing toner is used, and in the nonmagnetic single component developing method, a toner layer formed on a developing roller using a nonmagnetic single component developing toner contacts or does not contact a photoconductive medium when developing an image.

In the contact type nonmagnetic single component developing method, price competitiveness is good, but dot reproducibility, line reproducibility, and resolution are poor, which makes it difficult to obtain a high quality image. Meanwhile, in the case of the non-contact type nonmagnetic single component developing method, miniaturization is possible due to the simple structure of a developing apparatus, and color reproducibility, edge reproducibility, tone gradation, and resolution are good, which facilitates the production of a high quality image.

The nonmagnetic single component toner used in the non-contact developing method includes toner particles a binder resin to which internal additives such as a colorant, a charge control agent (CCA), a releasing agent, and the like, are uniformly added in order to improve chromaticity, a charge property, and a fusing property, and various external additives added to the toner particles that provide fluidity, charge stability, and a cleaning property.

In the non-contact type nonmagnetic single component developing method, to maintain good developing quality without contaminating a non-image area even after printing for a long time, a stable charge quantity and uniform charge quantity distribution of the toner should be continuously maintained. Thus, the type and the amount of external additives added to the toner particles are controlled.

By using two or more types of inorganic particles having different particle sizes as the external additives, a charge quantity, fluidity, and a wet-endurance of the toner may be controlled. The external additive is added to an untreated toner and is stirred in a high speed mixer, such as a Henschel mixer, and then is applied to the surface of the untreated toner. A state of external addition is varied depending on the amount of the external additive added, a stirring time, or a stirring rate, and physical properties of the toner and a degree of contamination of a developing member are varied based on the state of external addition.

Korean Patent Laid-Open Publication No. 1999-62642 discloses a toner for developing an electrostatic latent image, in which an external additive including ultrafine particles with a particle diameter of 30-200 nm and very ultrafine particles with a particle diameter of 5-30 nm are mixed.

Also, Japanese Patent Publication No. Hei 8-272130 discloses separately adding titanium oxide treated with silicone oil, zinc stearate, silane coupling agent, and the like so as to have a hydrophobicity of 5% or more to a toner having an average particle diameter of 5-15μm to prevent a charge quantity of the toner from increasing and a charge quantity during printing from decreasing, after general external addition.

Generally, the external addition process of a toner is performed by mixing a plurality of external additives at a time without considering the sizes and the types of the external additives. In this process, uniform coating on the outer surface of a toner particle cannot be expected, and thus, a uniform charge property may not be maintained and fluidity may not be improved. Also, a developing member is easily contaminated by external additives separated from the toner particles due to nonuniform external addition, thereby resulting in a contamination of an image.

### BRIEF SUMMARY

Additional aspects and/or advantages of the invention will be set forth in part in the description which follows and, in part, will be apparent from the description, or may be learned by practice of the invention.

An aspect of the present invention provides a method of preparing a toner in which numerous external additives having different sizes are uniformly coated on the surfaces of toner particles so that the external additives may not be separated from the surfaces of toner particles even when the toner is continuously used, thereby maintaining endurance of the toner and preventing a developing member from being contaminated.

According to an aspect of the present invention, there is provided a method of preparing a toner, including: adding a first external additive having an average primary particle diameter between about 30 nm and 200 nm to toner particles including a binder resin and a colorant and stirring the first external additive with the toner particles to form a first external additive layer on the surfaces of the toner particles; and adding a second external additive having an average primary particle diameter between about 5 nm and 30 nm to the toner particles having the first external additive layer and stirring the second external additive with the toner particles to form second external additive layers on the first external additive layers. A stirring line speed of the first external additive is less than a stirring line speed of the second external additive.

The stirring time during the addition of the first external additive may be shorter than the stirring time during the addition of the second external additive.

The forming of the first external additive layer may include stirring at a line speed of between about 20-30 m/sec.

The forming of the second external additive layer may include stirring at a line speed of between about 30-45 m/sec.

According to another aspect of the present invention, there is provided a method of preparing a toner, including: stirring, at a first speed, a first external additive having an average primary particle diameter of between about 30 nm to 200 nm with toner particles including a binder resin and a colorant so as to form first external additive layers on surfaces of the toner particles; and stirring, at a second speed which is greater than the first speed, a second external additive having an average primary particle diameter between about 5 nm and 30 nm with the toner particles having the first external additive layer so as to form second external additive layer on the first external additive layers.

According to another aspect of the present invention, there is provided a method of preparing a toner, including: mixing a first external additive having an average primary particle diameter between about 30 nm and 200 nm with toner particles including a binder resin and a colorant to form a first external additive layer on surfaces of the toner particles; and mixing a second external additive having an average primary particle diameter between about 5 nm and 30 nm with toner particles having the first external additive layer to form second external additive layers on the first external additive layers. The first external additive is mixed at a speed less than that of the second external additive.

According to another aspect of the present invention, there is provided a method of increasing an endurance of a toner, including: forming first external additive layers on surfaces of toner particles including a binder resin and a colorant by mixing at a first speed a first external additive having an average primary particle diameter between about 30 nm and 200 nm with the toner particles; and forming second external additive layers on the first external additive layers by mixing at a second speed a second external additive layer having an average primary particle diameter between about 5 nm and 30 nm with the toner particles having the first external additive layer. The second speed is greater than the first speed.

### BRIEF DESCRIPTION OF THE DRAWING

These and/or other aspects and advantages of the invention will become apparent and more readily appreciated from the following description of the embodiments, taken in conjunction with the accompanying drawing of which:

FIG. 1 is a flowchart of a method of preparing toner according to an embodiment of the present invention.

### DETAILED DESCRIPTION OF EMBODIMENT

Reference will now be made in detail to an embodiment of the present invention, examples of which are illustrated in the accompanying drawing, wherein like reference numerals refer to the like elements throughout. The embodiment is described below in order to explain the present invention by referring to the figure.

In a method of preparing a toner according to an embodiment of the present invention, external additives are individually added to toner particles including a binder resin and a colorant according to the sizes of the external additives and the mixture is stirred to form a uniform external additive coating layer on the surface of toner particles.

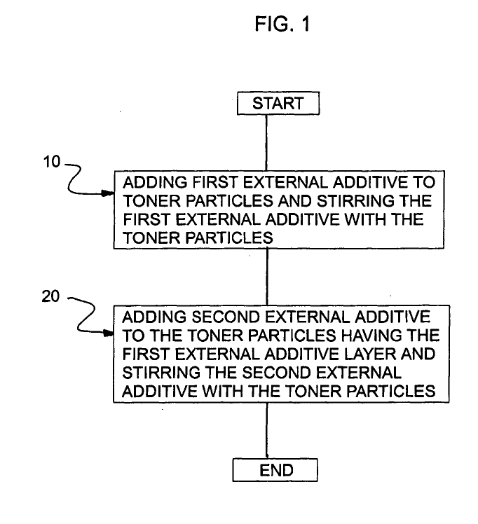

Referring to FIG. 1, this method of preparing a toner includes: adding a first external additive having an average primary particle diameter between 30 nm and 200 nm to toner particles including a binder resin and a colorant and stirring the first external additive with the toner particles in order to form a first external additive layer on the surface of the toner particles (operation 10); and adding a second external additive having an average primary particle diameter between 5 nm and 30 nm to the toner particles having the first external additive layer and stirring the second external additive and the toner particles in order to form a second external additive layer on the first external additive layer (operation 20). The stirring line speed of the first external additive is less than stirring line speed of the second external additive.

In the present embodiment, the first external additive having an average primary particle diameter between 30 nm and 200 nm and the second external additive having an average primary particle diameter between 5 nm and 30 nm are sequentially added to the toner particles. In other words, the first external additive having a larger average primary particle diameter is first added to and stirred with the toner particles, and then, the second external additive having a smaller average primary particle diameter than the first external additive is added to and stirred with the toner particles. Thus, the first external additive having a large size is sufficiently coated on the surface of the toner particle, and then, the second external additive having a small size is coated. Therefore, problems due to non-uniform external addition or the separation of external additives, which a conventional external addition process has, can be resolved.

The external additive may be an oxide of at least one metal selected from the group consisting of silicon, aluminum, titanium, tin, zirconium, strontium, tungsten, and iron, and may be titanium dioxide or silica.

The first external additive may have an average primary particle diameter between 30 nm and 200 nm, and preferably between 30 nm and 150 nm.

The second external additive may have an average primary particle diameter between 5 nm and 30 nm, between 5 nm and 20 nm, or between 7 nm and 16 nm.

When the second external additive has an average primary particle diameter less than 5 nm, it may be easily buried in fine prominences and depressions of the surface of the toner particles and it is difficult to control the charge property and fluidity of the toner. When the second external additive has an average primary particle diameter greater than 30 nm, it is difficult to sufficiently improve the fluidity of the toner.

A weight ratio of the first external additive to the second external additive may be varied depending on a developing system, but may be between 0.5:1 and 3:1 in the present embodiment.

When the amount of the first external additive exceeds the above range, the external additive layer becomes too thick, the charge quantity is reduced, and a fusing property is poor. When the amount of the first external additive is less than the above range, the fluidity of the toner is deteriorated.

Fine particles are generally surface treated with an organic material in order to reduce cohesiveness between the particles. Because of this surface treatment, the external additives have high resistance and hydrophobicity. If the particles are surface treated with an inorganic material, the external additives have electrical conductivity and low resistance.

The stirring line speed of the first external additive should be less than that of the second external additive because when the stirring speed of the first external additive is too large, the first external additive may become buried in the toner particles. The stirring line speed of the first external additive may be 20-30 m/sec and the stirring line speed of the second external additive may be 30-45 m/sec. When the stirring line speeds are smaller than the above ranges, a uniform distribution of the external additives cannot be obtained, and when the stirring line speeds are larger than the above ranges, the external additives are not placed on the surfaces of the toner particles but are buried in the toner particles.

In the subject method of the present embodiment, the stirring time for the first external additive may be shorter than that of the second external additive so that the total stirring time of the first external additive is not too long.

The first and second external additives may be stirred with the toner particles using a conventional mixer, such as a Henschel mixer.

The toner particles used in the method of the present embodiment include a binder resin and a colorant. In addition, additives such as a charge control agent and a releasing agent may be further included in the toner particles.

The binder resin in the toner particles is 70-95% by weight. Examples of the binder resin include polystyrene, polyester, epoxy resin, styrene/acrylate copolymer, and the like. Of these resins, polyester is proper for a color toner due to its good fusing property and transparence.

The performance of the toner may be affected by the acidity of the binder resin. As the acidity increases, the possibility the toner leaks to a toner layer regulator, for example, a blade, increases. Thus, low acidity can provide superior characteristics to the toner. Specifically, the acidity of the binder resin may be 3-12 mgKOH/g. When the acidity is less than 3 mgKOH/g, the charge property may be deteriorated. When the acidity of the binder resin is greater than 12 mgKOH/g, the stability of the charge quantity of the toner with respect to fluctuations in humidity may be reduced and the possibility for the toner to leak onto a blade increases.

Examples of the colorant contained in the toner particles include carbon black, aniline black, aniline blue, carco oil blue, chrome yellow, ultramarine blue, Dupont oil red, quinoline yellow, methylene blue chloride, phthalocyanine blue, malakite green oxalate, ramp black, rose vengal, rodamine dye or pigment, anthraquinone dye, monoazo- and bisazo dye, and quinacridone magenta dye.

When the colorant is carbon black, the average primary particle diameter may be 15-70 nm, in particular 20-55 nm and the surface area of the colorant may be 200 m²/g or less. The carbon black exhibits good dispersion and dissolution properties in other materials in a melt blending process.

The colorant is used in a sufficient amount for the toner to be colored. For example, the concentration of the colorant may be 0.5-10% by weight, 0.5-8% by weight, or 1-5% by weight. When the concentration of the colorant is less than 0.5% by weight, coloring is insufficient. When the concentration of the colorant is greater than 10% by weight, an image density is saturated but the developing performance of the toner is reduced.

The charge control agent and the releasing agent may be uniformly internally added to the binder resin to improve the charge property and the fusing property of the toner.

The toner must be able to be stably fixed on a developing roller by an electrostatic force. Since the electrostatic force of the toner is generated by a toner layer regulator, a stable and rapid charge rate of the toner is required. Thus, the charge control agent is necessary for a stable charge of the toner.

Examples of the charge control agent include chromium containing azo dyes, and salicylic acid compounds containing metal such as chromium, iron, and zinc, which are typical negative charge control agents. Besides these materials, various materials known in the art may be used.

The amount of the charge control agent may be 0.1-10% by weight. When the amount of the charge control agent is less than 0.1% by weight, the charge control agent has no effect, and when the amount of the charge control agent is greater than 10% by weight, the charge may be unstable.

Due to the addition of the charge control agent, the toner may have a charge per mass (Q/M) of about −5 to −30 μC/g. When the toner has a positive charge, the charge per mass may be of about 5 to 30 μC/g.

In order to achieve energy efficiency and a shorter warm-up time, a low temperature fusing property of the toner is required. Thus, the use of a releasing agent having a good fusing property in a broad temperature range is required.

Examples of the releasing agent include low molecular weight polypropylene wax, low molecular weight polyethylene wax, ester wax, paraffin wax, higher fatty acid, and fatty acid amide. The amount of the releasing agent may be 0.1-10% by weight. When the amount of the releasing agent is less than 0.1% by weight, the releasing agent has no effect, and when the amount of the releasing agent is greater than 10% by weight, poor offset, a reduction in fluidity, caking, and the like are caused.

The charge control agent, the releasing agent, etc. are contained in the toner through an internal addition method, in which the additives are added to the inside of the toner particles, or a method of depositing the additives on the surface of the toner particles. The internal addition method is generally used. In addition, a higher fatty acid and a metal salt thereof may be properly added to the toner particles to obtain a high quality image by protecting a photoconductive medium and preventing a deterioration of a developing property.

The present invention will be described in greater detail with reference to the following examples. The following examples are for illustrative purposes and are not intended to limit the scope of the invention.

### EXAMPLES

### Preparation Example

Toner particles having the following composition were obtained:
Binder resin (polyester): 90.5% by weight
Colorant (carbon black): 5% by weight
Negative charge control agent (Hodogaya, Fe complex): 2.5% by weight
Releasing agent (low molecular weight polypropylene wax): 2% by weight

These components were homogeneously premixed using a Heschel mixer, and then the pre-mixture was introduced into a twin-screw extruder to be extruded at 130° C., and the extrudate was cooled and solidified. Thereafter, an untreated toner having an average particle diameter of about 8 μm, which was not subjected to an external addition process, was obtained using a pulverization classifier.

In subsequent external addition processes, an external additive having the following composition was used and only processes of external addition were modified:
Silica A (average primary particle diameter 30-50 nm): 0.5% by weight
Silica B (average primary particle diameter 7-16 nm): 1.0% by weight
Titanium oxide (average primary particle diameter 50-150 nm): 0.5% by weight

### Example 1

The external additive prepared in the preparation example was externally added to the untreated toner particles prepared in the preparation example in a multi-step manner using a 20L Henschel mixer to prepare a toner according to an embodiment of the present invention.

First step: Silica A and titanium oxide particles were mixed with the toner particles, and then the mixture was stirred at a line speed of 20 m/sec for 90 seconds.

Second step: Silica B was mixed with the result from the first step, and then the resulting mixture was stirred at a line speed of 30 m/sec for 180 seconds.

### Comparative Example 1

The external additive prepared in the preparation example was externally added to the untreated toner particles prepared in the preparation example in the following manner using a 20L Henschel mixer to prepare a toner.

First step: Silica A, silica B, and titanium oxide particles were mixed with the toner particles, and the mixture was stirred at a line speed of 30 m/sec for 180 seconds.

### Comparative Example 2

The external additive prepared in the preparation example was externally added to the untreated toner particles prepared in the preparation example in the following manner using a 20L Henschel mixer to prepare a toner.

First step: Silica A and silica B particles were mixed with the toner particles, and the mixture was stirred at a line speed of 20 m/sec for 90 seconds.

Second step: Titanium oxide was mixed with the result from the first step, and then the resulting mixture was stirred at a line speed of 30 m/sec for 180 seconds.

### Experimental Example

An evaluation of the toners prepared in the Example and the Comparative Examples was performed using a 20 ppm printer. Image density (I/D), background (B/G, fog), i.e., non-image area density, and a degree of CR (charge roller) contamination were determined to evaluate the performance of each toner. The image density was determined by measuring a density of a solid pattern on a sheet of paper and the background density was determined by measuring a density in the non-image area on a photoconductive medium using a densitometer (available from SpectroEye GretagMacbeth). The degree of CR contamination was evaluated with the naked eye. The conditions of the experiment were as follows:
Surface potential of photoconductive medium (V₀): −700 V
Electrostatic latent image potential on photoconductive medium (VL): −100 V
Voltage applied to developing roller: Vp-p=1.8 KV, Frequency=2.0 kHz
Vdc=−500 V, Duty Ratio=35% (spherical wave)
Developing gap: 150-400 μm
Developing roller:
   (1) Aluminium roller
      Roughness: Rz=1-2.5 (after nickel plating)
   (2) Rubber roller (NBR elastic rubber roller)
      Resistance: 1×10⁵ to 5×10⁶ Ω
      Hardness: 50
Toner:
   Charge per mass (q/m)=−5 to −30 μC/g (on the developing roller after passing through a toner layer regulator)

Toner mass per area (M/A)=0.3 to 1.0 mg/cm² (on the developing roller after passing through a toner layer regulator)

TABLE 1
Image density

Number of sheets of paper

| Example No. | 0 | 1,000 | 2,000 | 3,000 | 4,000 | 5,000 |
|---|---|---|---|---|---|---|
| Example 1 | ο | ο | ο | ο | ο | Δ |
| Comparative | ο | ο | ο | ο | ο | Δ |
| Example 1 | | | | | | |
| Comparative | ο | ο | ο | ο | Δ | Δ |
| Example 2 | | | | | | |

TABLE 2
Background of non-image area

Number of sheets of paper

| Example No. | 0 | 1,000 | 2,000 | 3,000 | 4,000 | 5,000 |
|---|---|---|---|---|---|---|
| Example 1 | ο | ο | ο | ο | ο | Δ |
| Comparative | ο | ο | ο | ο | Δ | Δ |
| Example 1 | | | | | | |
| Comparative | ο | ο | ο | ο | ο | Δ |
| Example 2 | | | | | | |

TABLE 3
Degree of CR contamination

Number of sheets of paper

| Example No. | 0 | 1,000 | 2,000 | 3,000 | 4,000 | 5,000 |
|---|---|---|---|---|---|---|
| Example 1 | ο | ο | ο | ο | ο | ο |
| Comparative | ο | Δ | X | — | — | — |
| Example 1 | | | | | | |
| Comparative | ο | Δ | X | — | — | — |
| Example 2 | | | | | | |

In Table 1, “◯” represents that the image density was greater than 1.3, “Δ” represents that the image density was in the range of 1.1-1.3, and “×” represents that the image density was less than 1.1.

In Table 2, “◯” represents that the background of the non-image area had a density less than 0.14, “Δ” represents that the background of the non-image area had a density in the range of 0.15-0.16, and “×” represents that the background of the non-image area had a density greater than 0. 17.

In the toner prepared using the above-described method according to an embodiment of the present invention, since external additives are uniformly coated on the surfaces of toner particles, the endurance of the toner is maintained even when the toner was used for a long period of time and the external additives did not separate from the surfaces of toner particles, thereby preventing a developing member from being contaminated.

Although an embodiment of the present invention have been shown and described, the present invention is not limited to the described embodiment. Instead, it would be appreciated by those skilled in the art that changes may be made to the embodiment without departing from the principles and spirit of the invention, the scope of which is defined by the claims and their equivalents.

1. A method of preparing a toner, the method comprising:
adding a first external additive having an average primary particle diameter between about 30 nm and 200 nm to toner particles including a binder resin and a colorant and stirring the first external additive with the toner particles to form a first external additive layer on the surfaces of the toner particles; and
adding a second external additive having an average primary particle diameter between about 5 nm and 30 nm to the toner particles having the first external additive layer and stirring the second external additive with the toner particles to form second external additive layers on the first external additive layers,
wherein a stirring line speed of the first external additive is less than a stirring line speed of the second external additive.

2. The method of claim 1, wherein the first external additive is an oxide of at least one metal selected from the group consisting of titanium, aluminum, zinc, silicon, and zirconium.

3. The method of claim 1, wherein the second external additive is silica.

4. The method of claim 1, wherein the first external additive layer is stirred at a line speed of between about 20 m/sec and 30 m/sec.

5. The method of claim 1, wherein the second external additive layer is stirred at a line speed of between about 30 m/sec and 45 m/sec.

6. The method of claim 1, wherein a stirring time during the adding of the first external additive is shorter than a stirring time during the adding of the second external additive.

7. A method of preparing a toner, comprising:
stirring, at a first speed, a first external additive having an average primary particle diameter of between about 30 nm to 200 nm with toner particles including a binder resin and a colorant so as to form first external additive layers on surfaces of the toner particles; and
stirring, at a second speed which is greater than the first speed, a second external additive having an average primary particle diameter between about 5 nm and 30 nm with the toner particles having the first external additive layer so as to form second external additive layer on the first external additive layers.

8. The method of claim 7, wherein the first external additive has a average primary particle diameter of between 30 nm and 150 nm.

9. The method of claim 7, wherein the second external additive has an average primary particle diameter of between 7nm and 16 nm.

10. The method of claim 7, wherein a weight ration of the first external additive and the second external additive is between about 0.5:1 and 3:1.

11. The method of claim 7, wherein an amount of binder resin is between about 70% and 90% by weight.

12. The method of claim 7, wherein an acidity of the binder resin is between about 3 mgKOH/g and 12 mgKOH/g.

13. The method of claim 7, wherein the toner particles include a charge control agent and a releasing agent.

14. The method of claim 13, wherein an amount of the charge control agent is between about 0.1% and 10% by weight.

15. A method of preparing a toner, comprising:
mixing a first external additive having an average primary particle diameter of between about 30 nm and 200 nm with toner particles including a binder resin and a colorant to form a first external additive layer on surfaces of the toner particles; and
mixing a second external additive having an average primary particle diameter of between about 5 nm and 30 nm with toner particles having the first external additive layer to form second external additive layers on the first external additive layers,
wherein the first external additive is mixed at a speed less than that of the second external additive.

16. A method of increasing an endurance of a toner, comprising:
forming first external additive layers on surfaces of toner particles including a binder resin and a colorant by mixing at a first speed a first external additive having an average primary particle diameter of between about 30 nm and 200 nm with the toner particles; and
forming second external additive layers on the first external additive layers by mixing at a second speed a second external additive layer having an average primary particle diameter of between about 5 nm and 30 nm with the toner particles having the first external additive layer,
wherein the second speed is greater than the first speed.
